(19) United States
(12) Patent Application Publication
(10) Pub. No.: US 2013/0069775 A1
(43) Pub. Date: Mar. 21, 2013

(54) TIRE STATUS MONITORING APPARATUS

(71) Applicants: Hee Bum Lee, Gyunggi-do (KR); Jong Woo Han, Seoul (KR); Jong In Na, Seoul (KR); Jong Hyeong Song, Gyunggi-do (KR); Kyoung Soo Chae, Gyunggi-do (KR)

(72) Inventors: Hee Bum Lee, Gyunggi-do (KR); Jong Woo Han, Seoul (KR); Jong In Na, Seoul (KR); Jong Hyeong Song, Gyunggi-do (KR); Kyoung Soo Chae, Gyunggi-do (KR)

(73) Assignee: SAMSUNG ELECTRO-MECHANICS CO., LTD., Gyunggi-do (KR)

(21) Appl. No.: 13/324,865

(22) Filed: Dec. 13, 2011

(30) Foreign Application Priority Data
Sep. 16, 2011 (KR) 1020110093603

(51) Int. Cl. B60C 23/02

(52) U.S. Cl. 340/442

(57) ABSTRACT

Disclosed herein is a tire status monitoring apparatus including: a tire status measuring module installed in the inside of a tire to measure a tire status, thereby generating information on the tire status; an antenna valve transmitting the information on the tire status measured from the tire status measuring module and ventilating air to the tire according to the transmitted information on the tire status, thereby maintaining a constant air pressure in the inside of the tire; and a leaf spring having one end connected to the tire status measuring module and the other end connected to the antenna valve. Therefore, it is possible to reduce the number of processes such as hole forming and soldering processes for connection, have a simplified configuration, and easily connect and separate to between the tire status measuring module and the antenna valve.

### CROSS REFERENCE TO RELATED APPLICATION

This application claims the benefit of Korean Patent Application No. 10-2011-0093603, filed on Sep. 16, 2011, entitled “Tire Status Monitoring Apparatus”, which is hereby incorporated by reference in its entirety into this application.

### BACKGROUND OF THE INVENTION

1. Technical Field

The present invention relates to a tire status monitoring apparatus.

2. Description of the Related Art

An automobile is generally mounted with wheels and tires in order to transfer a torque and damp impact, or the like, transferred from a road, at the time of driving or braking thereof, simultaneously with supporting weight thereof.

It is required that the tire is fitted onto the wheel to absorb the impact transferred from the road while rotating integrally with the wheel and appropriately prevent slippage on the road at the time of braking, driving, and turning of the automobile. To this end, air pressure of the tire should always be maintained to be constant according to a change from the outside and a driving status.

In order to maintain the air pressure to be constant, the tire is installed with an air injection valve protruded outwardly of the tire while being in communication with the inside thereof so that air may be appropriately injected from the outside thereinto. In addition, a tire status measuring module for monitoring a current air pressure status of the tire is installed in the inside of the tire.

Here, the tire status measuring module installed in the inside of the tire and the air injection valve installed outside the tire should be connected to each other. According to the prior art, the tire status measuring module and the air injection valve are connected to each other by fitting or screwing a pin formed at the air injection valve into a hole formed in a substrate of the tire status measuring module or soldering corresponding connection portions.

The tire status monitoring apparatus according to the prior art as described above requires a process of forming the hole in the substrate of the tire status measuring module or a process of soldering the corresponding connection portions in order to connect the tire status measuring module and the air injection valve to each other and has a complicated structure due to a connection member such as a screw or a pin. In addition, the tire status measuring module and the air injection valve is not easily separated from each other at the time of replacement thereof.

### SUMMARY OF THE INVENTION

The present invention has been made in an effort to provide a tire status monitoring apparatus in which a substrate of a tire status measuring module monitoring tire pressure and an antenna valve transmitting information on a tire status measured from the tire status measuring module and ventilating air to a tire according to the transmitted information on the tire status are connected to each other using a leaf spring.

According to a preferred embodiment of the present invention, there is provided a tire status monitoring apparatus including: a tire status measuring module installed in the inside of a tire to measure a tire status, thereby generating information on the tire status; an antenna valve transmitting the information on the tire status measured from the tire status measuring module and ventilating air to the tire according to the transmitted information on the tire status, thereby maintaining a constant air pressure in the inside of the tire; and a leaf spring having one end connected to the tire status measuring module and the other end connected to the antenna valve.

The tire status measuring module may include a substrate having various electrical components mounted thereon and a first connection groove plating-formed in a side thereof connected to a first distal end of the leaf spring, wherein the electrical component measures air pressure and temperature statuses in the inside of the tire to generate the information on the tire status and the first connection groove corresponds to one end of the leaf spring.

The substrate may further have an upper plated surface provided on an upper surface thereof connected to one end of the leaf spring, the upper plating surface corresponding to one end of the leaf spring.

The tire status measuring module may further include: a support formed under the substrate to support the substrate; and a case receiving the substrate and the support therein to protect the substrate.

The antenna valve may include a valve stem transmitting the information on the tire status generated from the tire status measuring module, having first and second ventilating ports formed at both ends thereof in a hollow form so that air is ventilated to the tire according to information on a tire air pressure status among the transmitted information on the tire status, divided into a front end inserted into the inside of the tire and a rear end protruded to the outside of the tire, and having a second connection groove formed in the front end connected to the other end of the leaf spring in a circumferential direction, wherein the second connection groove corresponds to the other end of the leaf spring.

The valve stem may further include a step part formed at a position corresponding to the other end of the leaf spring so that the other end of the leaf spring and the second connection groove formed in the front end are not separated from each other after the other end of the leaf spring is inserted into the second connection groove, wherein the step part serves as a catching jaw.

The antenna valve may further include: a pressure maintaining member formed to enclose the rear end of the valve stem to inject the air into the inside of the tire or discharge the air to the outside thereof according to a contact degree of an outer surface of the tire at the time of ventilation of the air to the tire, thereby controlling internal air pressure of the tire to be maintained to be constant; and a valve cap provided at a distal end of the rear end of the valve stem so as to be detachable.

The leaf spring may include: a first distal end connected to the tire status measuring module; a second distal end connected to the antenna valve; and a bent part formed between the first and the second distal ends to thereby allow the first distal end to be connected to the tire status measuring module by horizontal tension and allow the second distal end to be connected to the antenna valve by vertical tension.

The first distal end may be formed to be extended from a side of the tire status measuring module toward an upper surface thereof.

The second distal end may correspond to a cross-sectional shape of the antenna valve, have an opening part for insertion or separation of the antenna valve, and be formed so that both ends of the opening part have horizontal elastic force.

### BRIEF DESCRIPTION OF THE DRAWINGS

FIG. 1 is a side view of a tire status monitoring apparatus according to a preferred embodiment of the present invention;

FIG. 2 is a cross-sectional view of the tire status monitoring apparatus shown in FIG. 1;

FIGS. 3A and 3B are views describing a method for connecting a substrate and a leaf spring to each other; and

FIGS. 4A and 4B are cross-sectional views taken along line I-I′ of FIG. 2 in order to describe a method for connecting a leaf spring and an antenna valve to each other.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

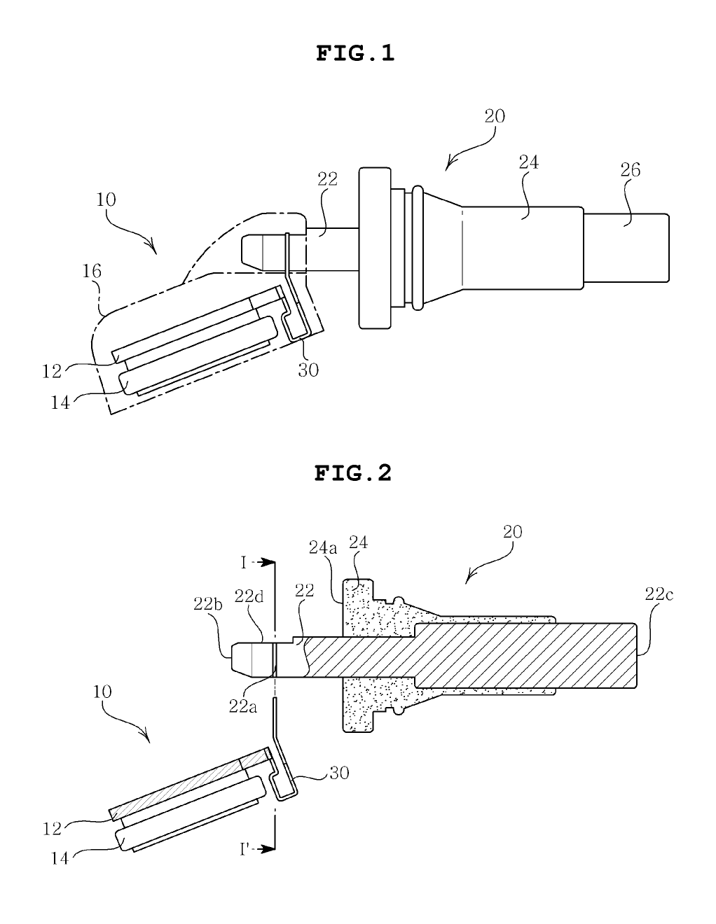

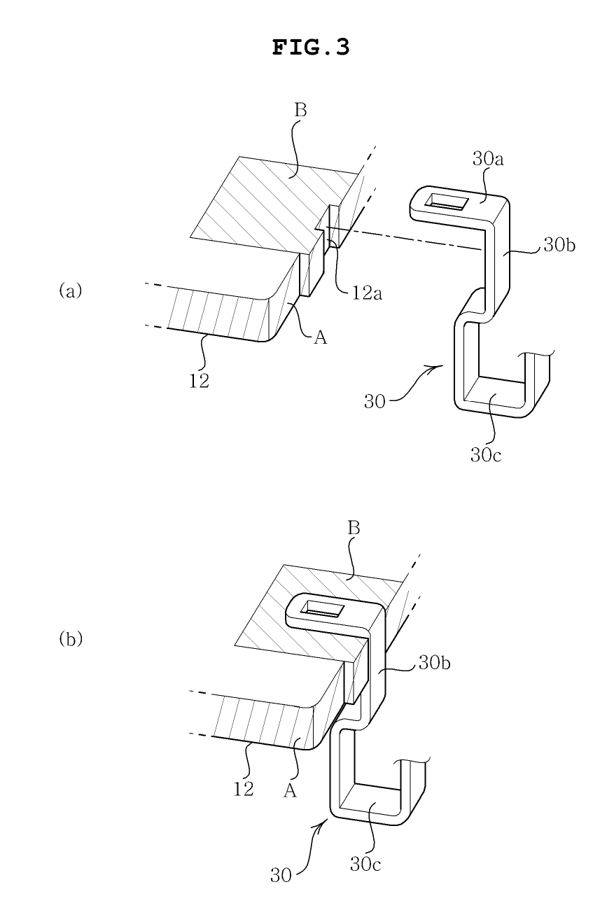

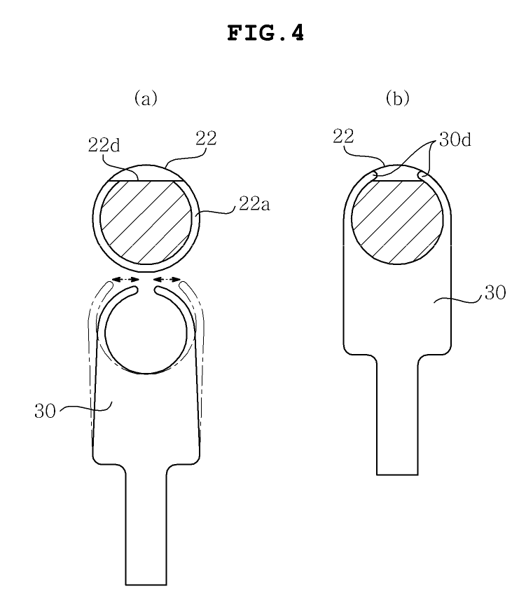

FIG. 1 is a side view of a tire status monitoring apparatus according to a preferred embodiment of the present invention; FIG. 2 is a cross-sectional view of the tire status monitoring apparatus shown in FIG. 1; FIGS. 3A and 3B are views describing a method for connecting a substrate and a leaf spring to each other; and FIGS. 4A and 4B are cross-sectional views taken along line I-I′ of FIG. 2 in order to describe a method for connecting a leaf spring and an antenna valve to each other.

Referring to FIGS. 1 to 4, the tire status monitoring apparatus according to the preferred embodiment of the present invention is configured to include a tire status measuring module 10, an antenna valve 20, and a leaf spring 30.

The tire status measuring module 10 is attached to a vehicle (more specifically, a wheel) to measure a tire status (for example, air pressure, internal temperature, or the like) for monitoring the tire status, thereby generating information on the tire status. A body of the vehicle is installed with a receiver receiving the information on the tire status measured from the tire status measuring module 10.

The tire status measuring module 10 includes a substrate 12 having various electrical components mounted thereon in order to measure the tire status.

The substrate 12 may be, for example, a printed circuit board (PCB). A side A of the substrate 12 is plated in order to be connected to a leaf spring 30 to be described below.

More specifically, the substrate 12 includes a first connection groove 12a formed in the plated side A thereof so as to be connected to the leaf sprint 30, wherein the first connection groove 12a corresponds to one end (more specifically, a first distal end 30b) of the leaf spring 30.

In addition, the substrate 12 may further have an upper plated surface B plated on an upper surface 12 thereof so that extended one end (more specifically, an upper surface distal end 30a) of the leaf spring 30 may also be connected to an upper surface thereof.

The substrate 12 and the leaf spring 30 are connected to each other in a scheme of inserting and pressing one end of the leaf spring 30 into the first connection groove 12a plating-formed in the side A of the substrate 12.

Meanwhile, the substrate 12 and the leaf spring 30 may also be connected to each other by injection-molding the leaf spring 30 at the time of molding the substrate 12.

The support 14 is formed under the substrate 12 to thereby support the substrate 12.

A case 16, which receives the substrate 12 and the support 14 therein to thereby protect the substrate 12, is made of an insulation member such as a rubber and a plastic so as not to have an effect on various electrical components mounted on the substrate 12.

The antenna valve 20, which serves an antenna transmitting the information on the tire status generated from the tire status measuring module 10 and an air ventilating valve ventilating air to the tire according to tire air pressure among the transmitted information on the tire status, includes a valve stem 22, a pressure maintaining member 24, and a valve cap 26.

The valve stem 22 is formed in a hollow form in which it has first and second ventilating ports 22b and 22c formed at both ends thereof so as to inject the air from the outside into the inside of the tire or discharge from the inside thereof to the outside, thereby ventilating the air, as shown in FIG. 2. In this configuration, the valve stem 22 may be divided into a front end inserted into the inside of the tire and a rear end protruded to the outside of the tire.

The valve stem 22 includes a second connection groove 22a formed in the front end thereof in a circumferential direction thereof so as to be connected to the leaf spring 30, wherein the second connection groove 22a corresponds to the other end (more specifically, a second distal end 30d) of the leaf spring 30.

In addition, the valve stem 22 may further include a step part 22d formed at a position corresponding to the other end of the leaf spring 30 in the front end thereof so that the other end of the leaf spring 30 and the second connection groove 22a are not separated from each other after the other end of the leaf spring 30 is inserted into the second connection groove 22a as shown in FIGS. 4A and 4B in order to enhance connection with the leaf spring 30, wherein the step part 22d serves as a catching jaw.

A length or a diameter of this valve stem 22 may be adjusted according to an antenna band that is to be designed.

The pressure maintaining member 24 is formed to enclose the rear end of the valve stem 22 protruded to the outside of the wheel to inject or discharge the air so that an outer surface of the tire contacts a front end surface 24a of the pressure maintaining member 24 at the time of ventilation of the air to the inside of the tire, thereby allowing internal pressure of the tire to be maintained to be constant.

The pressure maintaining member 24 is made of an insulation member such as a rubber or a plastic to thereby serve to protect the valve stem 22 without having an effect on antenna performance.

In addition, the valve stem 22 includes a detachable valve cap 26 provided at a distal end of the rear end thereof. The valve cap 26 may be removed at the time of the ventilation of the air to the tire and be again mounted at the time of completion of the air ventilation.

The leaf spring 30 elastically connects the tire status measuring module 10 and the antenna valve 20 to each other. That is, the tire status measuring module 10 and the antenna valve 20 may be electrically connected to each other through the leaf spring 30.

The leaf spring 30 includes the first distal end 30b connected to the tire status measuring module 10, the second distal end 30d connected to the antenna valve 20, and a bent part 30c formed between the first distal ends 30a and 30b and the second distal end 30d to thereby allow the first distal end 30b to be connected to the tire status measuring module 10 by horizontal tension and allow the second distal end 30d to be connected to the antenna valve 20 by vertical tension.

More specifically, the first distal end 30b of the leaf spring 30 is formed to correspond to the first connection groove 12a plating-formed in the side A of the substrate of the tire status measuring module 10 to thereby be inserted and pressed into the first connection groove 12a, such that the first distal end 30b of the leaf spring 30 is connected to the first connection groove 12a in a rivet form, as shown in FIGS. 3A and 3B. Here, as pressing force acting between the substrate 12 and the first distal end 30b of the leaf spring 30, tension in a horizontal direction is used.

Meanwhile, the leaf spring 30 may further have the upper surface distal end 30a formed by extending the first distal end 30b so as to correspond to the upper surface B of the substrate 12.

The second distal end 30d of the leaf spring 30 corresponds to a cross-sectional shape of the second connection groove 22a formed in the front end of the valve stem 22 of the antenna valve 20, has an opening part for insertion or separation of the valve stem 22, and is formed so that both ends of the opening part has horizontal elastic force to thereby be inserted and pressed into the second connection groove 22a, such that the first distal end 30b of the leaf spring 30 is connected to the second connection groove 22a in a rivet form, as shown in FIGS. 4A and 4B. Here, as pressing force acting between the valve stem 22 and the second distal end 30d of the leaf spring 30, tension in a vertical direction is used.

In addition, as described above, the second distal end 30d is caught in the catching jaw by the step part 22d formed at the front end of the valve stem 22 after the second distal end 30d of the leaf spring 30 is connected to the second connection groove 22a of the valve stem 22, thereby making it possible to enhance the connection.

As described above, in the case of the tire status monitoring apparatus according to the preferred embodiment of the present invention, the tire status measuring module and the antenna valve are connected to each other in the rivet form using the leaf spring 30, thereby making it possible to reduce the number of processes such as a process for forming a hole in the substrate or a process for connecting them to each other through soldering, have a simplified configuration, and easily connect and separate between the tire status measuring module and the antenna valve at the time of replacement thereof.

According to the preferred embodiment of the present invention, a rivet type connection device using the leaf spring is used, thereby making it possible to reduce the number of processes, have a simplified configuration, and easily connect and separate between the tire status measuring module and the antenna valve.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A tire status monitoring apparatus comprising:
a tire status measuring module installed in the inside of a tire to measure a tire status, thereby generating information on the tire status;
an antenna valve transmitting the information on the tire status measured from the tire status measuring module and ventilating air to the tire according to the transmitted information on the tire status, thereby maintaining a constant air pressure in the inside of the tire; and
a leaf spring having one end connected to the tire status measuring module and the other end to connected to the antenna valve.

2. The tire status monitoring apparatus as set forth in claim 1, wherein the tire status measuring module includes a substrate having various electrical components mounted thereon and a first connection groove plating-formed in a side thereof connected to a first distal end of the leaf spring, the electrical component measuring air pressure and temperature statuses in the inside of the tire to generate the information on the tire status and the first connection groove corresponding to one end of the leaf spring.

3. The tire status monitoring apparatus as set forth in claim 2, wherein the substrate further has an upper plated surface provided on an upper surface thereof connected to one end of the leaf spring, the upper plating surface corresponding to one end of the leaf spring.

4. The tire status monitoring apparatus as set forth in claim 2, wherein the tire status measuring module further includes:
a support formed under the substrate to support the substrate; and
a case receiving the substrate and the support therein to protect the substrate.

5. The tire status monitoring apparatus as set forth in claim 1, wherein the antenna valve includes a valve stem transmitting the information on the tire status generated from the tire status measuring module, having first and second ventilating ports formed at both ends thereof in a hollow form so that air is ventilated to the tire according to information on a tire air pressure status among the transmitted information on the tire status, divided into a front end inserted into the inside of the to tire and a rear end protruded to the outside of the tire, and having a second connection groove formed in the front end connected to the other end of the leaf spring in a circumferential direction, the second connection groove corresponding to the other end of the leaf spring.

6. The tire status monitoring apparatus as set forth in claim 5, wherein the valve stem further includes a step part formed at a position corresponding to the other end of the leaf spring so that the other end of the leaf spring and the second connection groove formed in the front end are not separated from each other after the other end of the leaf spring is inserted into the second connection groove, the step part serving as a catching jaw.

7. The tire status monitoring apparatus as set forth in claim 5, wherein the antenna valve further includes:
a pressure maintaining member formed to enclose the rear end of the valve stem to inject the air into the inside of the tire or discharge the air to the outside thereof according to a contact degree of an outer surface of the tire at the time of ventilation of the air to the tire, thereby controlling internal air pressure of the tire to be maintained to be constant; and
a valve cap provided at a distal end of the rear end of the valve stem so as to be detachable.

8. The tire status monitoring apparatus as set forth in claim 1, wherein the leaf spring includes:
a first distal end connected to the tire status measuring module;
a second distal end connected to the antenna valve; and
a bent part formed between the first and the second distal ends to thereby allow the first distal end to be connected to the tire status measuring module by horizontal tension and allow the second distal end to be connected to the antenna valve by vertical tension.

9. The tire status monitoring apparatus as set forth in claim 8, wherein the first distal end is formed to be extended from a side of the tire status measuring module toward an upper surface thereof.

10. The tire status monitoring apparatus as set forth in claim 8, wherein the second distal end corresponds to a cross-sectional shape of the antenna valve, has an opening part for insertion or separation of the antenna valve, and is formed so that both ends of the opening part have horizontal elastic force.
